(19) United States
(12) Patent Application Publication
(10) Pub. No.: US 2006/0144820 A1
(43) Pub. Date: Jul. 6, 2006

(54) Remote chamber methods for removing surface deposits

(76) Inventors: Herbert H. Sawin, Chestnut Hill, MA (US); Bo Bai, Cambridge, MA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/087,965

(22) Filed: Mar. 23, 2005

Related U.S. Application Data
(60) Provisional application No. 60/640,833, filed on Dec. 30, 2004.

(51) Int. Cl. B08B 6/00; C25F 1/00; B44C 1/22; C23F 1/00; C25F 3/30

(52) U.S. Cl. 216/63; 438/905; 134/1.1

(57) ABSTRACT

The present invention relates to an improved remote plasma cleaning method for removing surface deposits from a surface, such as the interior of a deposition chamber that is used in fabricating electronic devices. The improvement involves a fluorocarbon rich plasma pretreatment of interior surface of the pathway from the remote chamber to the surface deposits.

### BACKGROUND OF THE INVENTION

1. Field of the Invention

The present invention relates to methods for removing surface deposits by using an activated gas created by remotely activating a gas mixture comprising of oxygen and fluorocarbon. More specifically, this invention involves a fluorocarbon rich plasma pretreatment of interior surface of the pathway from the remote chamber to the surface deposits.

2. Description of Related Art

Remote plasma sources for the production of atomic fluorine are widely used for chamber cleaning in the semiconductor processing industry, particularly in the cleaning of chambers used for Chemical Vapor Deposition (CVD) and Plasma Enhanced Chemical Vapor Deposition (PECVD). The use of remote plasma sources avoids some of the erosion of the interior chamber materials that occurs with in situ chamber cleans in which the cleaning is performed by creating a plasma discharge within the PECVD chamber. While capacitively and inductively coupled RF as well as microwave remote sources have been developed for these sorts of applications, the industry is rapidly moving toward transformer coupled inductively coupled sources in which the plasma has a torroidal configuration and acts as the secondary of the transformer. The use of lower frequency RF power allows the use of magnetic cores which enhance the inductive coupling with respect to capacitive coupling; thereby allowing the more efficient transfer of energy to the plasma without excessive ion bombardment which limits the lifetime of the remote plasma source chamber interior.

The semiconductor industry has shifted away from mixtures of fluorocarbons with oxygen for chamber cleaning, which initially were the dominant gases used for in situ chamber cleaning for a number of reasons. First, the emissions of global warming gases from such processes was commonly much higher than that of nitrogen trifluoride (NF₃) processes. NF₃ dissociates more easily in a discharge and is not significantly formed by recombination of the product species. Therefore, low levels of global warming emissions can be achieved more easily. In contrast, fluorocarbons are more difficult to breakdown in a discharge and recombine to form species such as tetrafluoromethane (CF₄) which are even more difficult to break down than other fluorocarbons.

Secondly, it was commonly found that fluorocarbon discharges produced “polymer” depositions that require more frequent wet cleans to remove these deposits that build up after repetitive dry cleans. The propensity of fluorocarbon cleans to deposit “polymers” occurs to a greater extent in remote cleans in which no ion bombardment occurs during the cleaning. These observations dissuaded the industry from developing industrial processes based on fluorocarbon feed gases. In fact, the PECVD equipment manufacturers tested remote cleans based on fluorocarbon discharges, but to date have been unsuccessful because of polymer deposition in the process chambers.

However, if the two drawbacks as described above can be resolved, fluorocarbon gases are desirable for their low cost and low-toxicity.

While prior work has been done on perfluorocarbon/oxygen discharges with nitrogen addition to enhance the etching of silicon nitride. The enhancement is regarded as the result of the formation of NO by the discharge which in turn reacts with N on the silicon nitride surface, followed by the effective fluorination of Si atoms to form volatile products. C. H. Oh et al. Surface and Coatings Technology 171 (2003) 267.

### BRIEF SUMMARY OF THE INVENTION

The present invention relates to a method for removing surface deposits, said method comprising: (a) activating in a remote chamber a pretreatment gas mixture comprising fluorocarbon and optionally oxygen wherein the molar ratio of oxygen and fluorocarbon is less than 1:1; and thereafter (b) contacting said activated pretreatment gas mixture with at least a portion of interior surface of a pathway from the remote chamber to the surface deposits; (c) activating in the remote chamber a cleaning gas mixture comprising oxygen and fluorocarbon wherein the molar ratio of oxygen and fluorocarbon is at least 1:3; and thereafter (d) passing said activated cleaning gas mixture through said pathway; (e) contacting said activated cleaning gas mixture with the surface deposits and thereby removing at least some of said surface deposits.

### BRIEF DESCRIPTION OF THE DRAWING(S)

FIG. 1. Schematic diagram of an apparatus useful for carrying out the present process.

FIG. 2. Plot of the effect of transient oxygen shut off to Zyron® C318N4 (C₄F₈) on (a) gas emission, measured by FTIR, (b) etching rate.

### DETAILED DESCRIPTION OF THE INVENTION

Surface deposits removed in this invention comprise those materials commonly deposited by chemical vapor deposition or plasma-enhanced chemical vapor deposition or similar processes. Such materials include silicon, doped silicon, silicon nitride, tungsten, silicon dioxide, silicon oxynitride, silicon carbide and various silicon oxygen compounds referred to as low K materials, such as FSG (fluorosilicate glass) and SiCOH or PECVD OSG including Black Diamond (Applied Materials), Coral (Novellus Systems) and Aurora (ASM International).

One embodiment of this invention is removing surface deposits from the interior of a process chamber that is used in fabricating electronic devices. Such process chamber could be a Chemical Vapor Deposition (CVD) chamber or a Plasma Enhanced Chemical Vapor Deposition (PECVD) chamber.

The process of the present invention involves an activating step using sufficient power to form an activated gas mixture. Activation may be accomplished by any means allowing for the achievement of dissociation of a large fraction of the feed gas, such as: RF energy, DC energy, laser illumination and microwave energy. The neutral temperature of the resulting plasma depends on the power and the residence time of the gas mixture in the remote chamber. Under certain power input and conditions, neutral temperature will be higher with longer residence time. Here, preferred neutral temperature of activated cleaning gas mixture is over about 3,000 K. Under appropriate conditions (considering power, gas composition, gas pressure and gas residence time), neutral temperatures of at least about 6000K may be achieved, for example, with octafluorocyclobutane.

The activated gas is formed in a remote chamber that is outside of the process chamber, but in close proximity to the process chamber. The remote chamber is connected to the process chamber by any means allowing for transfer of the activated gas from the remote chamber to the process chamber. The remote chamber and means for connecting the remote chamber with the process chamber are constructed of materials known in this field to be capable of containing activated gas mixtures. For instance, aluminum and stainless steel are commonly used for the chamber components. Sometimes Al₂O₃ is coated on the interior surface to reduce the surface recombination.

A pretreatment gas mixture that is activated to treat the interior surface of the pathway through which an activated cleaning gas passes to the process chamber comprises fluorocarbon and optionally oxygen. A preferred pretreatment gas mixture has oxygen verses fluorocarbon molar ratio of less than 1:1. A more preferred pretreatment gas mixture contains no oxygen.

A cleaning gas mixture that is activated to remove the surface deposition comprises oxygen and fluorocarbon. A preferred cleaning gas mixture has oxygen verses fluorocarbon molar ratio of at least 1:3. A more preferred cleaning gas mixture has oxygen verses fluorocarbon molar ratio of at least from about 2:1 to about 20:1.

The fluorocarbon of the invention is herein referred to as a compound comprising of C and F. Preferred fluorocarbon in this invention is perfluorocarbon compound. A perfluorocarbon compound in this invention is herein referred to as a compound consisting of C, F and optionally oxygen. Such perfluorocarbon compounds include, but are not limited to tetrafluoromethane, hexafluoroethane, octafluoropropane, hexafluorocyclopropane decafluorobutane, octafluorocyclobutane, carbonyl fluoride and octafluorotetrahydrofuran.

The gas mixture that is activated to form either the pretreatment gas mixture or the cleaning gas mixture may further comprise carrier gases such as argon and helium.

A preferred embodiment of the present invention is a method for removing surface deposits from the interior of a process chamber that is used in fabricating electronic devices, said method comprising: (a) activating in a remote chamber a pretreatment gas mixture comprising perfluorocarbon compound and no oxygen; (b) contacting said activated pretreatment gas mixture with at least a portion of interior surface of a pathway from the remote chamber to the surface deposits; (c) activating in the remote chamber a cleaning gas mixture comprising oxygen and perfluorocarbon compound, wherein the molar ratio of oxygen and perfluorocarbon compound is at least 1:3, using sufficient power for a sufficient time such that said gas mixture reaches a neutral temperature of at least about 3,000 K to form an activated cleaning gas mixture; and thereafter (d) contacting said activated cleaning gas mixture with the interior of said deposition chamber and thereby removing at least some of said surface deposits.

It was found that a fluorocarbon rich plasma pretreatment of interior surface of the pathway from the remote chamber to the surface deposits can increase the etching rate. By “fluorocarbon rich plasma”, it is meant that the gas mixture comprising fluorocarbon and optionally oxygen wherein the molar ratio of oxygen and fluorocarbon is less than about 1:1 is activated to form a plasma. In one embodiment of this invention, as described in Example 1, when the cleaning gas mixture is composed of O₂, Zyron® C318N4 (C₄F₈) and Ar, a rapid closing and opening of the oxygen valve for a period of a few seconds can increase the etching rate. In another embodiment of this invention, as described in Examples 2 and 3, a pretreatment gas mixture consisting of fluorocarbon and Ar is activated and passes through the heat exchanger, a portion of pathway from the remote chamber to the surface deposits. This treatment can also increase the etching rate.

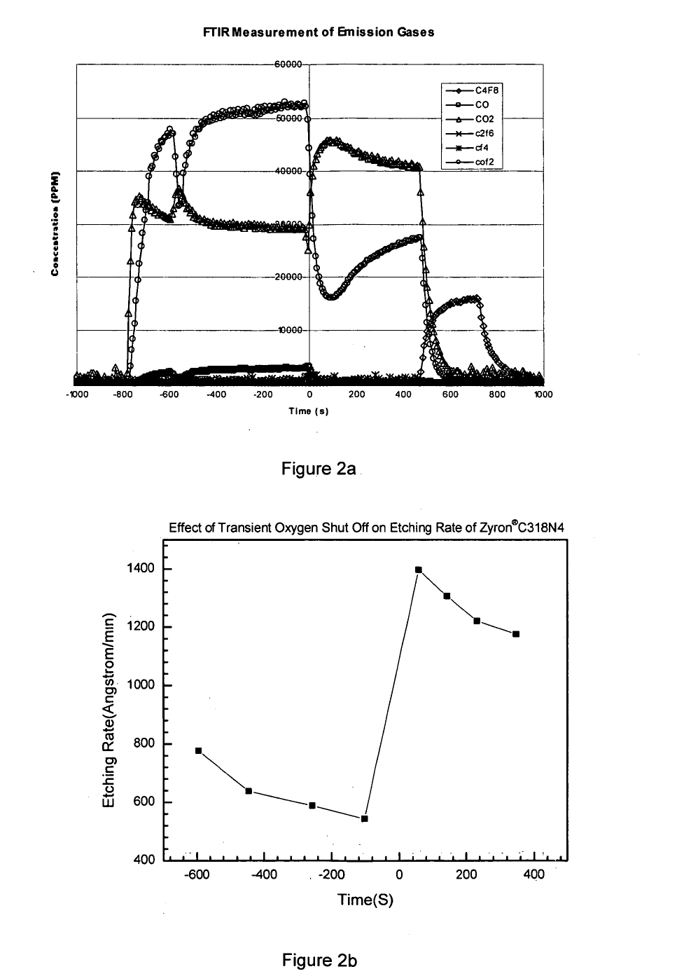

It was also found that at the similar conditions of this invention, the drawbacks of the perfluorocarbon compound, i.e. global warming gases emission and polymer deposition, can be overcome. In the cleaning process of this invention, no significant polymer depositions on the interior surface of process chamber was found. The global warming gas emissions were also very low as shown in FIG. 2a.

The following Examples are meant to illustrate the invention and are not meant to be limiting:

### EXAMPLES

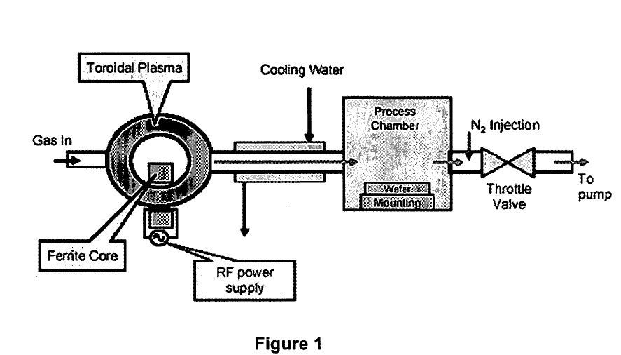

FIG. 1 shows a schematic diagram of the remote plasma source and apparatus used to measure the etching rates, plasma neutral temperatures, and exhaust emissions. The remote plasma source is a commercial toroidal-type MKS ASTRON®ex reactive gas generator unit made by MKS Instruments, Andover, Mass., USA. The feed gases (e.g. oxygen, fluorocarbon, Argon) were introduced into the remote plasma source from the left, and passed through the toroidal discharge where they were discharged by the 400 KHz radio-frequency power to form an activated gas mixture. The oxygen is manufactured by Airgas with 99.999% purity. The fluorocarbon is Zyron® C318N4 with minimum 99.99 vol % of octafluorocyclobutane, and Zyron® 8020 with minimum 99.9 vol % of octafluorocyclobutane, both are manufactured by DuPont and supplied in cylinders. Nitrogen source in the examples is nitrogen gas manufactured by Airgas with grade of 4.8 and Argon is manufactured by Airgas with grade of 5.0. The activated gas then passed through an aluminum water-cooled heat exchanger to reduce the thermal loading of the aluminum process chamber. The surface deposits covered wafer was placed on a temperature controlled mounting in the process chamber. The neutral temperature is measured by Optical Emission Spectroscopy (OES), in which rovibrational transition bands of diatomic species like C₂ and N₂ are theoretically fitted to yield neutral temperature. See also B. Bai and H. Sawin, Journal of Vacuum Science & Technology A 22 (5), 2014 (2004), herein incorporated as a reference. The etching rate of the surface deposits by the activated gas is measured by interferometry equipment in the process chamber. N₂ gas is added at the entrance of the pump both to dilute the products to a proper concentration for FTIR measurement and to reduce the hang-up of products in the pump in the case that wet pump is used. FTIR was used to measure the concentration of species in the pump exhaust.

### Example 1

It was discovered that after certain periods of use, the etching rate of Zyron® C318N4 will drop to approximately one half of the previous rate. At the same time a much larger amount of COF₂ in the effluent gases was observed. It was also found that rapid closing and opening of the oxygen valve for a period of a few seconds could increase the etching rate back to the previous level.

In this experiment, the feeding gas composed of O₂, Zyron® C318N4 (C₄F₈) and Ar, wherein O₂ flow rate is 1750 sccm, Ar flow rate is 2000 sccm, C₄F₈ flow rate is 250 sccm. Chamber pressure is 2 torr. The 400 KHz 8.9 KW RF power was turned on at −800 seconds and the feeding gas was activated to a neutral temperature estimated to be 5000 K. The activated gas then entered the process chamber and etched the SiO₂ surface deposits on the mounting with the temperature controlled at 100° C. At the time of zero second, the oxygen valve was shut off for two seconds and then reopened. As a result of this oxygen feed transient, the COF₂ emission decreased abruptly and the CO₂ emission increased to maintain the carbon mass balance. After this transient, COF₂ concentration slowly increased while CO₂ concentration slowly decreased. However, after five minutes, the COF₂ and CO₂ concentration of emission leveled and did not appear to be returning to the prior levels before the O₂ induced transition. The results are shown in FIG. 2a. As demonstrated in FIG. 2b, etching rate jumped up at the transient closing off of oxygen. The etching rate then slowly decreased and leveled off corresponding to the COF₂ and CO₂ concentration change in the emission gases. The RF power was turned off at 450 seconds.

### Example 2

This experiment was designed to measure the effect of the fluorocarbon rich plasma treatment on the interior surface of the apparatus. The etching rate was measured as 900 Angstrom/min according to the conditions described below before the fluorocarbon rich plasma treatment. The feeding gas composed of O₂, Zyron® 8020 (C₄F₈) and Ar, wherein O₂ flow rate is 1750 sccm, Ar flow rate is 2000 sccm, C₄F₈ flow rate is 250 sccm. Chamber pressure is 2 torr. The feeding gas was activated by 400 KHz 8.8 KW RF power to a neutral temperature of estimated to be 5000 K. The activated gas then passed through the heat exchanger connection, entered the process chamber and etched the SiO₂ surface deposits on the mounting with the temperature controlled at 100° C.

Then the heat exchanger connection between the remote plasma source and the process chamber was treated by fluorocarbon rich plasma. The feeding gas mixture for the treatment consisted of 250 sccm Zyron® 8020 and 2000 sccm Ar. After activated by 400 KHz 7.0 KW RF power, the gas mixture passed through the heat exchanger for 2 minutes.

After the treatment, the etching rate was measured again under the same condition as before the treatment. The etching rate was found to be 1350 Angstrom/min, 30% higher than the one before the treatment.

### Example 3

This experiment was designed to measure the effect of the fluorocarbon rich plasma treatment on the interior surface of the apparatus. The etching rate was measured as 850 Angstrom/min according to the conditions described below before the fluorocarbon rich plasma treatment. The feeding gas composed of O₂, C₃F₈ and Ar, wherein O₂ flow rate is 1000 sccm, Ar flow rate is 2750 sccm, C₃F₈ flow rate is 250 sccm. Chamber pressure is 2 torr. The feeding gas was activated by 400 KHz 6.0 KW RF power to a neutral temperature of estimated to be 4500 K. The activated gas then passed through the heat exchanger connection, entered the process chamber and etched the SiO₂ surface deposits on the mounting with the temperature controlled at 100° C.

Then the heat exchanger connection between the remote plasma source and the process chamber was treated by fluorocarbon rich plasma. The feeding gas mixture for the treatment consisted of 250 sccm C₃F₈ and 2750 sccm Ar. After activated by 400 KHz 5.0 KW RF power, the gas mixture passed through the heat exchanger for two minutes.

After the treatment, the etching rate was measured again under the same condition as before the treatment. The etching rate was found to be 1150 Angstrom/min, 30% higher than the one before the treatment.

What is claimed is:

1. A method for removing surface deposits, said method comprising:
(a) activating in a remote chamber a pretreatment gas mixture comprising fluorocarbon and optionally oxygen wherein the molar ratio of oxygen and fluorocarbon is less than 1:1; and thereafter
(b) contacting said activated pretreatment gas mixture with at least a portion of interior surface of a pathway from the remote chamber to the surface deposits;
(c) activating in the remote chamber a cleaning gas mixture comprising oxygen and fluorocarbon wherein the molar ratio of oxygen and fluorocarbon is at least 1:3; and thereafter
(d) passing said activated cleaning gas mixture through said pathway;
(e) contacting said activated cleaning gas mixture with the surface deposits and thereby removing at least some of said surface deposits.

2. The method of claim 1 wherein said pretreatment gas mixture contains no oxygen.

3. The method of claim 1 wherein said surface deposits is removed from the interior of a deposition chamber that is used in fabricating electronic devices.

4. The method of claim 1 wherein said gas mixture is activated by an RF power source, a DC power source or a microwave power source.

5. The method of claim 1 wherein neutral temperature of said activated cleaning gas mixture is at least about 3000 K.

6. The method of claim 1 wherein said fluorocarbon is a perfluorocarbon compound.

7. The method of claim 1 wherein said gas mixture further comprises a carrier gas.

8. The method of claim 1, wherein the surface deposit is selected from a group consisting of silicon, doped silicon, silicon nitride, tungsten, silicon dioxide, silicon oxynitride, silicon carbide and various silicon oxygen compounds referred to as low K materials.

9. The method of claim 1, wherein molar ratio of oxygen and fluorocarbon of said cleaning gas mixture is at least from about 2:1 to about 20:1
